(19) United States
(12) Patent Application Publication
(10) Pub. No.: US 2013/0154367 A1
(43) Pub. Date: Jun. 20, 2013

(54) POWERING OF DEVICES

(71) Applicants: John Mark Counsell, Wirral (GB); Matthew John Stewart, Airdrie (GB)

(72) Inventors: John Mark Counsell, Wirral (GB); Matthew John Stewart, Airdrie (GB)

(73) Assignees: THE UNIVERSITY OF STRATHCLYDE, Glasgow, Strathclyde (UK); BUILDING RESEARCH ESTABLISHMENT LTD, Watford, Hertfordshire (UK)

(21) Appl. No.: 13/579,700

(22) PCT Filed: Feb. 21, 2011
(86) PCT No.: PCT/GB11/50334

§ 371 Date: Feb. 28, 2013

(30) Foreign Application Priority Data
Feb. 19, 2010 (GB) 1002832.2

(51) Int. Cl. H02J 4/00

(52) U.S. Cl. CPC H02J 4/00
USPC 307/24; 307/31

(57) ABSTRACT

An apparatus and method for a powering a network of devices, the apparatus comprising a power supply, means for inputting a parameter related to desired performance or power usage of the network, means for determining network load, means for generating an error signal using the parameter related to desired performance or power usage of the network, the network load, and measured power of the power supply, and means for using the error signal to determining how the power is utilised.

This invention relates to the powering of devices. In particular, but not exclusively, it relates to a method and apparatus for providing power to, and most efficiently using power by, a network of devices. The invention in particular relates to most efficiently using energy derived from lower carbon sources.

It is becoming more and more common to supplement mains power supplied to a building with locally provided sustainable energy sources (i.e. lower carbon sources), such as sources based upon photovoltaic (PV) energy (‘solar cell devices’), wind turbines, hydroelectric sources or other sustainable or ‘green’ sources.

Often, both a mains supply and a sustainable supply are provided as power inputs to a building, a group of buildings or other locations, where they may be combined and used to power devices within the building.

The availability of sustainable power in these circumstances can vary throughout the day or other time periods. For example, PV sources only directly generate solar power when the sun is shining upon them or at least in a certain minimum ambient level of light. Wind turbines are of course very dependent upon prevailing wind speed, and so on. It is desirable to maximise the use of sustainable energy when this is available.

Many computers and similar devices can connect to networks via so-called Ethernet ports, and Ethernet or CATS cabling. It is also now possible to transmit power over Ethernet networks (known as Power Over Ethernet (PoE) and to power relatively low power devices such as laptop computers, printers or other devices directly over the Ethernet network. This is convenient since it means that a device can simply be plugged into an Ethernet network and not require a separate power supply and mains supply. PoE may, currently, typically be used to provide power requirements of up to about 33 watts.

The present invention arose in an attempt to provide an improved method of utilising sustainable power wherever possible.

According to the present invention there is provided apparatus for a powering a network of devices, comprising:

a power supply;

means for inputting a parameter related to desired performance or power usage of the network;

means for determining network load;

means for generating an error signal using the parameter related to desired performance or power usage of the network, the network load, and measured power of the power supply; and

means for using the error signal to determining how the power is utilised.

The power supply may comprise one or more energy sources.

Preferably, at least one of the energy sources of the power supply produces ‘green’ or sustainable energy, such as one or more photovoltaic cells (PV), wind turbines, hydroelectric sources, or other low or zero carbon sources.

The means for determining network load is preferably a sensing means. The sensing means may continuously measure the total network power, or the sensing means may determine the network power at set intervals.

The parameter related to the desired performance or power usage of the network preferably relates to sustainable or ‘green’ energy. The parameter is preferably an energy performance set-point. The energy performance set-point is a value that corresponds to the proportion of the total power used by the network that should be derived from sustainable or ‘green’ sources. Although the set-point will not usually be a direct measure of the use of carbon by the energy source (in terms of, for example, kg CO₂/second), it may in some embodiments represent this. Thus, if a scale of 0 to 1 is used, 0 being no carbon (i.e. 100% of power from sustainable sources), and 1 being no sustainable energy, an ideal value for the set-point is 0. In practice, the set-point may well be set higher than this as 0 may be difficult or impossible to achieve. The performance set-point will generally be chosen by an operator or user depending on the circumstances.

The parameter related to the desired performance or power usage of the network may relate to the network load. This parameter may be equal to the already determined network load, and the means for generating an error signal will then use the network load and measured power of the power supply

The energy produced by energy sources for which the power has been measured, preferably the sustainable or ‘green’ sources, may be less than the amount of energy used or required by the network. In these circumstances, the additional energy required by the network may be supplied by one or more additional energy sources, for example, a mains power source. The power supplied by such additional power supplies would not be used to calculate the error signal. The apparatus may, therefore, include at least one energy source for which the power is not measured.

The means for generating the error signal and the means for using the error signal may be provided in the same device, or the means may be contained within separate devices. If the means for generating and using the error signal are provided in separate devices, there are preferably also means for transmitting the error signal between the two devices.

The means for generating an error signal is preferably a comparison means. The comparison means may be a comparator.

The means for using the error signal to determine how the power is utilised is preferably a controller. Alternatively, the means for using the error signal to determine how the power is utilised are associated with the devices of the network.

Preferably, the controller is adapted to use the error signal to produce a control signal, the control signal being transmittable to at least one device of the network, and the control signal determining how the power is utilised at the device or devices.

The controller may be adapted to use an algorithm, where the control signal may then be generated by the algorithm. This may be software, firmware or hardware based, or a combination thereof.

All of the devices of the network may receive the control signal. Alternatively, the controller may transmit the control signal to only select devices. For example, the controller may transmit the control signal only to devices of a particular type, such as devices which contain rechargeable batteries.

Preferably, the control signal is adapted to instruct the devices of the network to adjust the power by a certain amount and each device has a means that allows it to decide how the change in power will be achieved. The means associated with each device may comprise a hardware means, a software means, or a combination of these. Alternatively, the means may be smart controllers associated with the devices.

The devices of the network may be arranged to act independently or in a combined way to affect total load or performance over the network.

However, if the error is zero, the control signal may instruct the devices to maintain their current performance, or perhaps a ‘null’ signal (or no signal) is transmitted.

Alternatively, if the network comprises the same or similar types of device, for example devices which include rechargeable batteries, the control signal may contain specific instructions, for example the control signal may be designed to alter the way in which the battery is charged, depending upon the error signal received by the controller.

The error signal and/or the control signal may be adapted to be transmittable over the actual power transmission path, or the error signal and/or the control signal may be separately transmitted. In embodiments where it is transmitted over the power transmission path, it may be transmitted over Ethernet, via mains signalling, via a wireless mechanism in which power is also transmitted wirelessly or by other mechanism.

Alternatively, the error signal and/or the control signal may be transmitted, at least partially, over a separate transmission path to the power.

The power supply to the controller and the network of devices may be an AC supply (e.g. two or more AC supplies and in one or more ‘combined’ AC supplies out).

Alternatively, the power supply to the controller and the network of devices may be a DC supply. This may be provided from AC input sources (e.g. via rectifies or other AC/DC converters) or from all DC inputs or a combination of AC and DC inputs.

In one embodiment, the invention comprises a measured power supply, an error signal, and a controller, the controller being adapted to transmit a control signal generated by the controller to a router, and the router adapted to provide the control signal over an Ethernet or other network to a plurality of devices.

According to the present invention in a further aspect, there is provided a method of using power, comprising:

measuring the power provided by at least one power source;

measuring the network load;

calculating an achieved performance using the power of the at least one power source and the network load;

using the achieved performance and a parameter relating to desired performance or power usage of the network to generate an error signal;

using the error signal to determine how the power is utilised.

At least one of the power sources measured is preferably a sustainable or ‘green’ energy source, such as one or more photovoltaic cells (PV), wind turbines, hydroelectric sources, or other low or zero carbon sources.

The power supplied may be measured at a specific point in time, or over a particular period of time.

The total network load may be measured at a specific point in time, or over a particular period of time, the time chosen corresponding to the time used for the measured input power.

The parameter relating to the desired performance or power usage of the network preferably relates to sustainable or ‘green’ energy. The parameter is preferably an energy performance set-point. The energy performance set-point is a value that corresponds to the proportion of the total power used by the network that should be derived from sustainable or ‘green’ sources.

Alternatively, the parameter relating to the desired performance or power usage of the network may relate to the network load. This parameter may be equal to the already determined network load, and the method may comprise using the achieved performance and the parameter to generate an error signal.

The measured network load may be greater than the measured power provided by the at least one power source as energy may be additionally provided by at least one energy source that is not measured, for example, a mains power source.

The error signal is preferably generated by comparing the achieved performance of the system to the energy performance set-point that has been input into, or generated by, the system. In this way, the achieved performance can be used to track a desired performance set by the set-point, creating a ‘feedback mechanism’.

How the power is utilised is preferably determined by a controller. The controller is adapted to use the error signal to determine how the power is utilised. Alternatively, the devices of the network are adapted to use the error signal to determine how the power is utilised.

Preferably, the controller is adapted to use the error signal to produce a control signal, where the control signal is transmitted to at least one device of the network of devices, and the devices are adapted to use the control signal to determine how the power is utilised.

However, if the error is zero, the control signal may instruct the devices to maintain their current performance, or a ‘null’ signal (or no signal) may be transmitted.

The controller may comprise an algorithm which is applied to the error signal to compute a control signal. The algorithm may be software, firmware or hardware based, or combinations thereof.

The control signal may be transmitted to all devices of the network. Alternatively, the control signal may only be transmitted to select devices.

Preferably, on receipt of the control signal, the device is able to alter its power consumption by a certain amount. The device preferably determines the precise method by which the alteration in power consumption is achieved.

One or more of the devices of the network may include a rechargeable battery and the control signal may be adapted to at least partially determine a charging regime of the battery, and/or determine a balance between charging and directly powering the device.

At least some of the devices of the network may be adapted to be in communication with each other and/or with a further network device, where the devices are adapted to communicate to affect total load performance over the network.

The error signal and/or control signal may transmitted over the same power transmission line as the power, or separately.

The error signal and/or control signal may be transmitted, at least partially, over a separate transmission path to the power.

In other embodiments, the network load may simply be matched to the power supplied.

Embodiments of the invention will now be described, by way of example only, with reference to the accompanying schematic drawings, in which:

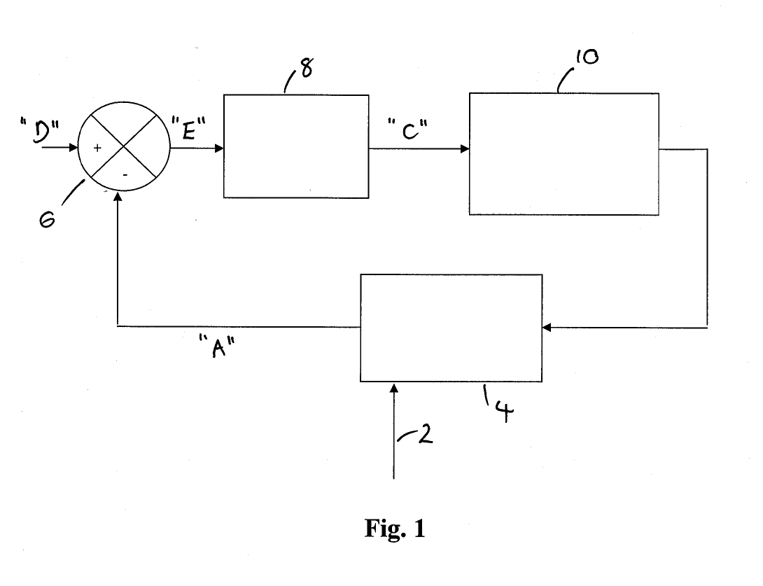

FIG. 1 shows a power supply arrangement;

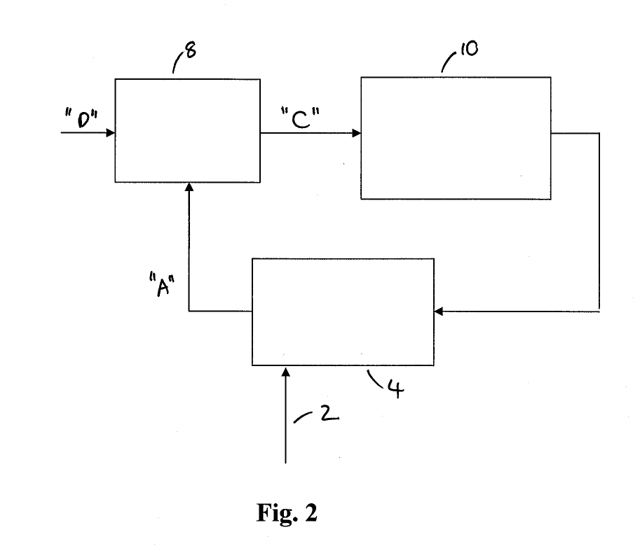

FIG. 2 shows an alternative power supply arrangement; and

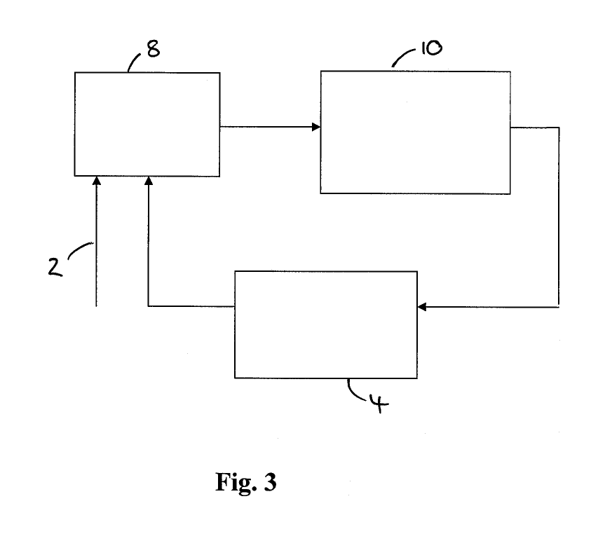

FIG. 3 shows a further alternative power supply arrangement.

Referring to the figures, FIG. 1 shows very schematically an embodiment of the invention. In this embodiment, a power supply 2, for example a photovoltaic (PV) power supply, is input into the system. This may alternatively be a mains supply of which a portion is from one or more (remote or local) sustainable sources, or a combination of a mains supply and local supply.

The amount of power provided by the sustainable source or sources, at a point in time or over a period of time, is compared to a measurement of the total performance of the network, such as the total load. The total load is detected and measured by a sensor 4. The comparison gives an achieved performance “A” of the system.

The network generally comprises more than one device, and the total load is equal to the sum of the energy used by each device. The network may, for example, be a computer network comprising computers and monitors, a heating network comprising storage heaters, or a general household network comprising white-goods, for example.

The total network load may be measured at a specific point in time. The total load is then equal to the sum of the energy usage of each device of the network at that point in time. Alternatively, the network load may be measured over a period of time. The total load then corresponds to the sum of the individual energy consumptions of each device over that interval of time.

The load measurement chosen will depend on the supplied power measurement; the time or time intervals used for both measurements should generally be the same.

The achieved performance “A” is compared by a comparator 6 to an input set-point “D”, which is a value corresponding to the ideal amount of the total energy used by the load that should come from sustainable sources. The comparison of the achieved performance “A” to and the desired performance “D” generates an error “E” between these two values.

The error “E” is then input into a controller which uses an algorithm to compute the error “E” to a control signal “C”. The control signal is transmitted to the network of devices 10. The devices of the network then alter their power consumption, for example increase or decrease their power consumption, according to the instructions contained within the control signal “C”. The precise means by which the devices alter their power consumption is determined by the devices themselves. For example, if the devices are laptop computers, they may reduce their energy consumption by reducing the amount by which the battery is being charged, dimming the monitor, or slowing the processor speed.

If the error “E” is zero, the control signal “C” will not instruct the devices of the network to alter their power consumption. Instead, the devices of the network will be instructed to maintain the same power consumption. Alternatively, if the error is zero, a ‘null’ signal (or no signal) may be transmitted.

The network performance sensor 4 will then detect the new power consumption of the network. The new power consumption is compared to the power provided by the measured power supply 2 to generate a new achieved performance value and the entire process repeats itself.

The system provides a performance regulation to ensure that the network as a whole, whatever it consists of and whatever the properties of the power supply are, tries to drive the error to zero (or to another desired, or realistically achievable, value). There is in general no need for prior knowledge of the load, number of devices, or supply characteristics.

In other embodiments, the controller 8 uses the achieved performance “A” and desired performance “D” to generate the error signal as well as the control signal “C”. FIG. 2 shows this schematically. In some embodiments, the error signal may be used as the control signal “C”. Such embodiments (as well as others) need not contain a controller, only a comparison means.

FIG. 3 shows very schematically another embodiment. In this embodiment, the controller 8 compares the network performance determined by sensor 4 to a power measurement of the amount of power provided by the power supply 2 to generate the error. The controller 8 uses this error signal to provide the one or more devices of the network 10 with instructions relating to power consumption, by either transmitting the error directly to the devices, or by generating a control signal using the error which is then transmitted to the devices. In this embodiment, the network load will track the amount of power supplied so that the power that is being used by the network matches the power supplied by the power supply 2 that is being measured. In other words, the load is adjusted to match the power supplied.

The above embodiments of the invention may be used in PoE (or partial PoE) environments for example for computers, laptops, monitors, or any other equipment capable of being powered over Ethernet. Embodiments of the invention may also be used in mains power environments, particularly when the network comprises larger or more power-hungry devices such as white-goods, heating, cooling, and or visual equipment etc, or in other environments.

The error ‘signal’ used in embodiments may be simply a value, e.g. a numerical value, such as an index, or may be any other type of signal or value which can be used to control or influence the performance of devices.

1. An apparatus for a powering a network of devices, comprising:
a power supply;
means inputting a parameter related to desired performance or power usage of the network;
means for determining network load;
means for generating an error signal using the parameter related to desired performance or power usage of the network, the network load, and measured power of the 10 power supply; and
means for using the error signal to determining how the power is utilised.

2. An apparatus as claimed in claim 1, wherein the power supply comprises one or more energy sources.

3. An apparatus as claimed in claim 2, wherein at least one of the energy sources of the power supply produces ‘green’ or sustainable energy.

4. An apparatus as claimed in claim 1, wherein the means for determining network load is a sensing means.

5. An apparatus as claimed in claim 1, wherein the parameter related to the desired performance or power usage of the network relates to sustainable or ‘green’ energy.

6. An apparatus as claimed in claim 1, wherein the parameter is an energy performance set-point corresponding to the proportion of the total power used by the network that should be derived from sustainable or ‘green’ sources.

7. An apparatus as claimed in claim 1, wherein the apparatus further comprises at least one energy source for which the power is not measured.

8. An apparatus as claimed in claim 1, wherein the means for generating the error signal is a comparison means.

9. An apparatus as claimed in claim 1, wherein the means for using the error signal to determine how the power is utilised is a controller.

10. An apparatus as claimed in claim 9, wherein the controller is adapted to use the error signal to produce a control signal, the control signal being transmittable to at least one device of the network, and the control signal determining how the power is utilised at the device or devices.

11. An apparatus as claimed in claim 9, wherein the controller is adapted to use an algorithm.

12. An apparatus as claimed in claim 10, wherein the control signal is adapted to instruct the devices of the network to adjust the power by a certain amount and each device has a means that allows it to decide how the change in power will be achieved.

13. An apparatus as claimed in claim 1, wherein the devices of the network are arranged to act independently to affect total load or performance over the network.

14. An apparatus as claimed in claim 1, wherein the devices of the network are arranged to act in a combined way to affect total load or performance over the network.

15. An apparatus as claimed in claim 10, wherein the error signal and/or the control signal are adapted to be transmittable over the actual power transmission path.

16. A method of using power, comprising:
measuring the power provided by at least one power source;
measuring the network load;
calculating an achieved performance using the power of the at least one power source and the network load;
using the achieved performance and a parameter relating to desired performance or power usage of the network to generate an error signal;
using the error signal to determine how the power is utilised.

17. A method as claimed in claim 16, wherein at least one of the power sources measured is a sustainable or ‘green’ energy source.

18. A method as claimed in claim 16, wherein the power supplied is measured at a specific point in time, or over a particular period of time.

19. A method as claimed in claim 16, wherein the total network load is measured at a specific point in time, or over a particular period of time.

20. A method as claimed in claim 16, wherein the parameter relating to the desired performance or power usage of the network relates to sustainable or ‘green’ energy.

21. A method as claimed in claim 16, wherein the parameter is an energy performance set-point value that corresponds to the proportion of the total power used by the network that should be derived from sustainable or ‘green’ sources.

22. A method as claimed in claim 16, wherein power is additionally provided by at least one energy source that is not measured.

23. A method as claimed in claim 16, wherein the error signal is generated by comparing the achieved performance of the system to the energy performance set-point that has been input into, or generated by, the system.

24. A method as claimed in claim 16, further comprising a controller adapted to use the error signal to determine how the power is utilised.

25. A method as claimed in claim 16, wherein the controller is adapted to use the error signal to produce a control signal, where the control signal is transmitted to at least one device of the network of devices, and the devices are adapted to use the control signal to determine how the power is utilised.

26. A method as claimed in claim 25, wherein the controller comprises an algorithm, wherein the algorithm is applied to the error signal to compute a control signal.

27. A method as claimed in claim 26, wherein one or more of the devices of the network may include a rechargeable battery and the control signal is adapted to at least partially determine a charging regime of the battery, and/or determine a balance between charging and directly powering the device.

28. A method as claimed in claim 16, wherein at least some of the devices of the network are adapted to be in communication with each other and/or with a further network device, wherein the devices are adapted to communicate to affect total load performance over the network.

29. A method as claimed in claim 24, wherein the error signal and/or control signal may transmitted over the same power transmission line as the power, or separately.

30. (canceled)

31. (canceled)

32. An apparatus or method as claimed in claim 1, wherein the parameter related to the desired performance or power usage of the network relates to the network load.

33. An apparatus or method as claimed in claim 1, wherein the network load is matched to the power supplied.
